(19) United States
(12) Patent Application Publication
(10) Pub. No.: US 2009/0311449 A1
(43) Pub. Date: Dec. 17, 2009

(54) METHOD OF MANUFACTURING AN INSULATED, IMPACT RESISTANT WINDOW

(76) Inventors: Hans Mark Fehlmann, Georgetown, MA (US); Jeffrey Pratt, Orange, MA (US); John Storms, Largo, FL (US); Michael W. Sullivan, Upton, MA (US); David W. Avison, Townsend, MA (US); Karen Hayden, Nashua, NH (US); Frank A. Mannarino, Medway, MA (US)

Correspondence Address: NORRIS MCLAUGHLIN & MARCUS, P.A., 721 ROUTE 202-206, P.O.BOX 5933, BRIDGEWATER, NJ, 08807-5933, US

(21) Appl. No.: 12/481,950

(22) Filed: Jun. 10, 2009

Related U.S. Application Data
(60) Provisional application No. 61/060,552, filed on Jun. 11, 2008.

(51) Int. Cl. E06B 3/66; C03C 27/12

(52) U.S. Cl. 428/34; 156/109

(57) ABSTRACT

An insulated glass unit (IGU) is provided. The IGU meets the industry standards for impact resistance while significantly reducing the weight of the IGU compared to conventional IGUs. In particular, the two pane IGUs of the present invention can meet or exceed industry standards for various wind storm criteria while reducing the weight and cost of the IGU. The IGU only requires one layer of film to meet the performance of previous IOU designs that require two or more layers of film laminated to two or more surfaces of glass.

### CROSS REFERENCE TO RELATED APPLICATION

This application claims the benefit of U.S. Provisional Patent Application No. 61/060,552, filed Jun. 11, 2008, the entirety of which is hereby incorporated by reference into this application.

### BACKGROUND OF THE INVENTION

1. Field of the Invention

The present invention relates to insulated glass units. More particularly, the present invention relates to insulated glass units that are impact resistant.

2. Description of Related Art

Insulated glass units (or “IGU”s) are used in windows to reduce heat transfer from both residential and commercial building interiors during cold or hot weather. IGUs are typically formed by a spacer assembly sandwiched between two or more glass lites, or panes, (hereinafter used interchangeably) with an air space between each adjacent lite. The space between the lites may be filled with air or an inert gas like argon or krypton which would provide better insulating performance.

A spacer assembly typically comprises a frame structure extending peripherally about the unit, a sealant material, or backfill, adhered both to the glass lights and the spacer assembly, and may contain a desiccant for absorbing atmospheric moisture within the unit. The margins of the glass lights are flush with or extend slightly outwardly from the spacer assembly. The sealant extends continuously about the frame structure periphery and its opposite sides so that the space within the IGU is hermetic.

IGUs are sometimes constructed to be impact resistant. In conventional IGUs, impact resistant IGU's have been constructed using laminated glass, which is two pieces of glass laminated to a PVB interlayer. Two pieces make up the impact portion of the pane; another piece is needed to make an IGU. Alternatively, impact resistance has been accomplished by adhering or laminating safety films or laminates to the surface of each lite or plane of glass. These techniques have a number of disadvantages.

When more than two panes of glass are used, that significantly increases the weight of the IGU, the cost of construction, the cost of transport, and the time and cost of installation. Laminating safety films to each pane of glass also has its disadvantages.

The more layers of safety film used, the more negatively the aesthetic appearance of the window is affected and the poorer the U Factor. The distortion levels are increased with each additional layer of film added to the unit. Additionally, each time film is laminated to glass, there is a chance for a defect to occur.

It would be desirable to have an IOU that minimizes or eliminates the problems with prior art IGUs while providing impact resistance. In particular, it would be desirable to have an IGU that meets or exceeds the various wind storm criteria (such ASTM 1886, 1996) while reducing the weight and construction costs of prior art IGUs.

### SUMMARY OF THE INVENTION

An IGU with one pane of glass with a polymer film and one pane of glass without a film, and a method of making the IOU are provided. The IGU is an impact resistant unit that has a first pane of glass with a polymeric film adhered or bonded onto one side of the pane of glass. A second pane of glass is linked to the first plane of glass to form the glass unit. The second pane of glass does not have a polymeric film adhered to either side. A spacer is positioned between the first and second panes of glass, linking the first pane to the second pane of glass and creating an insulating cavity in the glass unit between the first and second panes of glass. Additional insulating cavities can be created by including additional panes of glass.

A channel along the outer perimeter of the glass unit is created between the two panes of glass and the spacer. In some embodiments, the channel is filled with backfill, such as butyl or silicone. In other embodiments, the channel is not backfilled but sealed by some other means, such as tape or otherwise adhered to the IGU frame.

In the construction, the first pane of glass is positioned so that the polymeric film side is placed in contact with the spacer. Alternatively, the film on the first pane of glass is trimmed back from the edge of the glass and the spacer is placed in contact with surface of the glass and the film is within the circumference of the spacer.

In the method and IGU of the invention, a single ply or multi-ply, polymeric film is laminated, adhered, bonded or otherwise secured onto the surface of a pane of glass. The film is trimmed to the glass either by cutting the film flush with the edge of the glass, or by deleting the film from the edge of the glass. The pane of glass with the film layer makes up one pane of the insulated glass unit.

A spacer is then run along the edge or close to the edge of a second pane of glass, which second pane of glass can be either clear plain float glass, or a low-e coated glass, set back to the sight line of the window. If a low-e coating is used, it can be edge deleted, which is sometimes recommended by the low-e glass manufacturer.

The two panes of glass are then positioned so that the film side of the first pane of glass is placed in contact with the spacer placed on the second pane of glass. The composition of these two panes linked together by the spacer forms the insulated glass unit (alternatively referred to as an “IGU”). For improved thermal properties, the unit can be filled with an inert gas, such as Argon or Krypton. In some constructions, when the spacer is set back from the edge of the panes, a channel is formed around the perimeter of the IGU between the two panes of glass and the spacer.

Preferably, the channel in between the two panes and the spacer on the outer perimeter of the unit is filled with a structural adhesive or glazing compound to complete the unit. This unit is then glazed into the window frame by way of a structural adhesive, glazing compound, glazing tape, and/or combination thereof.

The polymeric film used on the first pane of glass is comprised of at least a single ply but may contain multiple layers, such as in a composite or film laminate. For improved UV-rejection and durability, a layer of ultraviolet (UV) light absorbing film can be placed on the outermost surface of the film, i.e., the surface that would be exposed to UV light from the sun first.

By reducing the number of laminations (of film onto glass) required down to one, the chance of a defect and scrap occurring are cut in half. Additionally, only half the manpower and time is required to run one piece instead of two. Less inventory is required because, again, only one piece of laminated film to glass is required for each unit, instead of the two required by the prior art IGUs.

All of these enhancements lead to a more cost effective, economically attractive product that is simpler and easier to produce.

Weight reduction is a significant benefit of this design of the present invention. Most hurricane rated impact windows currently produced are made with laminated glass technology. This technology involves bonding two panes of glass together through the use of a polymeric interlayer. A third pane of glass is typically needed to produce an insulated glass unit. The decrease in weight results in savings when shipping the final product. Since most freight charges are based on weight, a 30-50% reduction in weight is a substantial improvement to the manufacturer.

An additional benefit to decreased weight is that it is easier to install the windows. Since the weight is reduced by up to half, installation is much easier. Larger windows that would sometimes require two or more people, and even possibly a hoist, can be done by one person since windows produced using this method is much lighter.

The method of providing impact resistant IGUs allows for windows to be produced that are more environmentally friendly. The production of glass requires a high amount of energy and produces a larger carbon footprint than does the production of polymeric film. By removing one layer of glass, an environmentally beneficial product is produced. Also, since the design allows for the use of a wide array of low-e glass coatings, the homeowner benefits from reduced heating and cooling costs with windows properly designed for their location.

The design allows the window fabricator to produce the impact windows directly at their facility. Typically for laminated glass windows, the window fabricator has to order the laminated glass as the typical window fabricator does not have the resources to install their own autoclave to make laminated glass. As a result, most window fabricators have to order the laminated glass from larger companies, such as the glass manufacturers. In addition to being more expensive, this process requires a waiting period for the glass to be made and shipped.

When constructing the inventive IGU, the window fabricator can produce impact glass on demand when it is needed. Because a film or laminate can be applied at the fabricator's factory, a leaner more productive manufacturing environment with shorter lead times and less inventory is possible. In addition, the inventive design allows for a variety of films or laminates to be used interchangeably with any number of low-e coatings.

### BRIEF DESCRIPTION OF THE DRAWINGS

The following drawings are for illustrative purposes only and are not intended to limit the scope of the present invention in any way:

FIG. 1 illustrates a side view of one embodiment of an insulated glass unit prepared according to the invention.

FIG. 2 illustrates a side view of an alternate embodiment of an insulated glass unit prepared according to the invention.

FIG. 3 illustrates a side view of an alternate embodiment of an insulated glass unit prepared according to the invention.

FIG. 4. illustrates a side view of one embodiment of a polymeric film composite useful in an insulated glass unit of the invention

FIG. 5 illustrates insulated glass unit prepared according to the invention mounted in frame.

### DETAILED DESCRIPTION

### Overview

According to one embodiment of the invention, an insulated glass unit (referred to as an “IGU”) is provided. The IGU of the present invention meets the industry standards for impact resistance while significantly reducing the weight of the IGU compared to conventional IGUs. In particular, the two pane IGUs of the present invention is designed to meet or exceed such industry standards for various wind storm criteria. The IGU's made in accordance with the invention meet impact standards while providing superior visual appearance to conventional IGU's made with polymeric films. Triple pane IGUs with two insulating cavities are also provided.

The inventive IGUs require only one layer of film be laminated or adhered to one surface of one pane of glass to meet the same performance standards of previous IGU designs that utilize two or more layers of film laminated to two or more surfaces of glass. As a result, scrap, manpower, time and materials are significantly reduced.

In one aspect, the impact resistant insulated glass unit of the present invention contains only two glass panes that are linked or connected together to form the IJGU. The IGU contains a spacer between the two panes of glass creating an insulating cavity between the two panes of glass when both panes of glass are secured to the spacer. Only one pane of glass has a polymeric film adhered onto the inner side of that pane of glass. The second pane of glass does not have a polymeric film adhered to inner surface of the pane. In another aspect, the IGU contains additional panes of glass to create additional insulating cavities.

The two panes of glass and the spacer, when linked together, create a channel along the outer perimeter of the glass unit. Backfill is placed in the channel along the outer perimeter of the IGU to seal the unit.

As the insulating criteria for windows are raised, one method for increasing the insulating value of an IGU is to include a second airspace or insulating cavity by adding a third pane of glass. According, the invention as describe for double pane IGUs can also be applied to triple pane IGUs with two insulating cavities between the three panes of glass. In a triple pane IGU, a polymeric film is applied or adhered to one of the glass surfaces on the interior of the IGU. As there are four inner surfaces in a triple pane IGU, polymeric film can be adhered to more than one of the inner surfaces, but less than all four of the surfaces. Preferably, one of the four inner surfaces without a polymeric film has a low-e coating. This application can be extended to IGUs with more than three panes of glass.

### Description of Preferred Embodiment

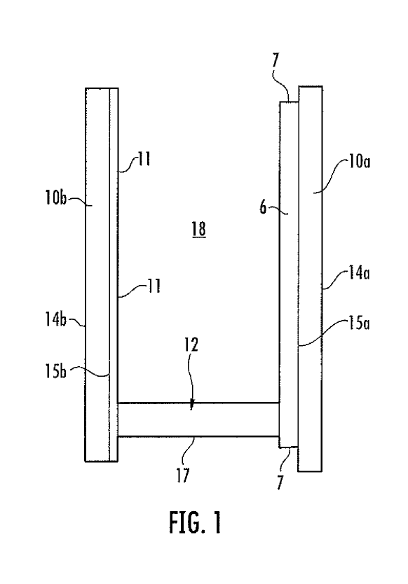

Referring to FIG. 1, in one embodiment an IGU 1 has two panes of glass; a first pane of glass 10a and a second pane of glass 10b. Each pane of glass 10a and 10b have an outer surface 14a and 14b respectively that face the exterior of the IGU and an inner surface 15a and 15b respectively that face the interior of the IGU 1. A polymeric film 6 is laminated or adhered (used interchangeably unless otherwise noted) or otherwise bonded to the inner surface of only one of the two panes of glass; in the Figures, the film 6 is adhered to the inner surface 15a of the first pane of glass 10a. Alternatively, the film 6 can be adhered to the inner surface 15b of the second pane of glass 10b instead of the first pane 10a. The glass, polymeric film and other components shown in the figure are not drawn to scale but are drawn so that the configuration of the components can be easily seen.

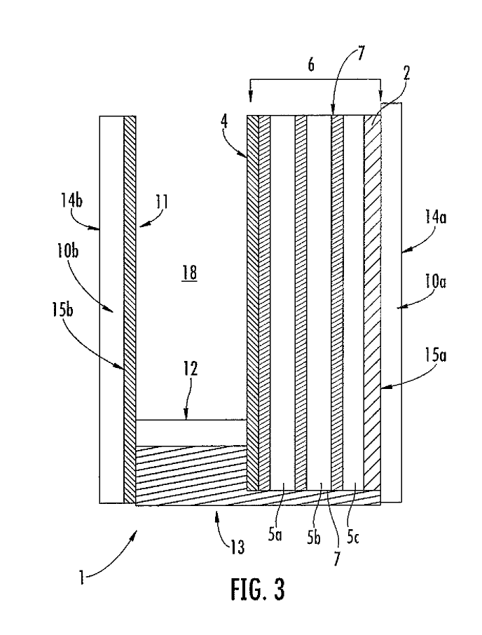

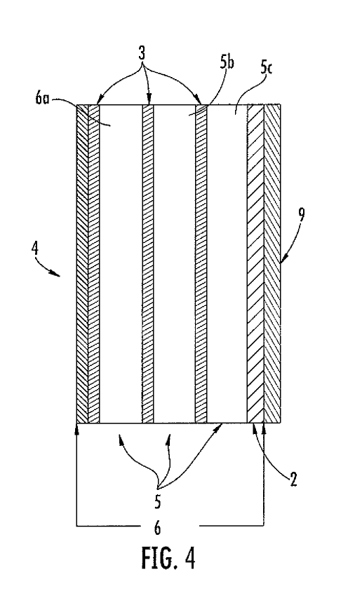

The pane of glass 10a with the polymeric film 6 can be any type typically used in the industry suitable for the intended purpose, such as for example, clear float glass, heat strengthened, tempered, or tinted, or any combination of properties. The polymeric film 6 can be any type of film that provides the required impact resistance such as, for example, a single ply polymeric film or a composite or laminate made up of multiple plies of the same or different polymer films. In the embodiment of FIG. 1 the polymeric film 6 shown is a single ply polymeric film, however in other embodiments a composite or laminate (discussed in more detail below with regard to FIGS. 3 and 4) is used. There is no limit on the number of plies that can be used to make up the polymeric film 6 so long as it functions to provide the desired level of impact resistance.

In the embodiment of FIG. 1, the ends 7 of the polymeric film composite 6 are trimmed back slightly, from about 1/32 to about ¼ of an inch, from the edge of glass 10a. The polymeric film composite 6, however, can alternatively be trimmed flush with the edge of the pane 10 of glass. Whether trimmed flush with the edge or back from the edge, the edges of the composite can be sealed to the glass 10a using weatherable tape, such as metal tape, or glazing compound around the edge of the glass 10a to encapsulate the edge to prevent moisture from entering the IGU.

The second pane of glass 10b can be any type of glass suitable for the intended use of the IGU. The second pane of glass 10b can be the same or different from the first pane of glass 10a. It does not, however, require a polymeric film laminated or adhered to the inner surface 15b when the first pane 10a has a film 6. The second plane of glass 10b does not have a polymeric film on the outer surface 14b either. Accordingly, the IGU has two panes of glass, only one of which has a polymeric film laminated or adhered to the surface.

The second pane of glass can be annealed, tempered, heat strengthened, or low-e glass. Optionally, low-e coated glass 11 on the inner surface 15b is used in order to improve the thermal properties of the window. The selection of low-e coating 11 is not critical to the impact resistant property and is typically chosen based on regional requirements. The low-e coating 11 may be edge deleted as necessary per the glass manufacturer's recommendations. In an alternate embodiment, the low-e coating is the type that provides complete or partial UV absorbance.

To form the IGU, a spacer 12 is positioned in between the glass panes 10a and 10b to form the insulated glass unit 1. The two panes 10a and 10b of glass are adhered to the spacer 12 using methods and materials known in the industry. The spacer 12 often has a polyisobutylene (PIB) layer that is run along the first glass pane 10a. The second pane 10b is then placed on top. The unit 1 is then run through a heat and oven press. The exact equipment and process varies depending on the spacer used and is known to those skilled in the art. In the embodiment shown in FIG. 1, the spacer 12 is adhered directly to the polymeric film 6.

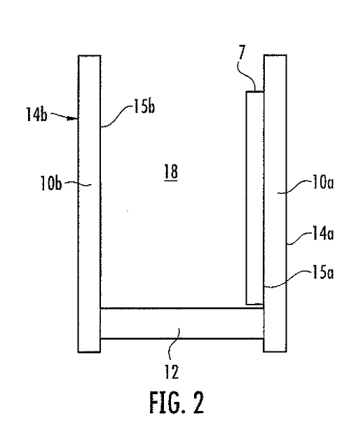

In alternate embodiments, however, the ends 7 of the film 6 are trimmed back to a greater degree from the edge of the pane 10 of glass and the spacer 12 is adhered directly to the inner surface 15a of the first pane of the glass 10a, such as shown in FIG. 2. In such an embodiment, the edge of the polymeric film can be sealed with weatherable tape prior or glazing compound prior to the spacer being adhered to the glass.

An insulating cavity 18 in the IGU 1 is formed between the first and second panes of glass 10a and 10b. The insulating cavity 18 can be filled with any type of gas including air. Alternatively, for improved thermal properties, the IGU can be filled with an inert gas, such as for example, Argon or Krypton.

In some embodiments, a channel 17 is formed on the outer perimeter of the IGU 1 between the two panes of glass 10a and 10b and the spacer 12. The channel 17 is optionally backfilled with a glazing compound 13 (alternatively referred to as “backfill” 13) as shown in FIG. 2. The backfill 13 can be any type of compound used in the industry to seal IGUs. Preferably the backfill 13 is butyl or what is commonly referred to as “hot melt butyl,” which is commercially available. Alternatively, silicone and other structural adhesives, and/or mixtures of different compounds can be used depending on the specific application.

In an alternate embodiment, the IGU has more than two panes of glass and more than one insulating cavity. The increase in the number of insulating cavities corresponds to the number of additional panes of glass. For example, in a triple pane IGU, there are two insulating cavities created by the three panes of glass. In a triple pane IGU there are four inner glass surfaces, two inner surfaces for each outer pane of glass and two inner surfaces for the third pane of glass in the middle. In a triple pane IGU a polymeric film 6 is adhered to one of the four inner surfaces and preferably, a low-e coating is applied to a different inner surface. In an especially preferred embodiment the film is adhered to the inner surface of one of the outer panes of glass and the low-e coating is applied to the inner surface of the other outer panes of glass. The remainder of the IGU is constructed as described with reference to a double pane IOU.

Referring to FIGS. 3 and 4 the polymeric film 6 is a composite or laminate made up of three plies 5a, 5b, and 5c of a polymeric based film 6. Three plies are shown in FIG. 3, however, more or less can be used and the exact number will depend on the specific application. The individual films 5a, 5b, and 5c can be the same type of polymer or different types of polymers. In a preferred embodiment the polymer film is polyethylene terephthalate (PET) and the composite contains three plies of PET. Other types of polymers can be used to make the films, either alone or in combination such as, for example, urethane, polycarbonate, and polypropylene. The individual plies are laminated together using a lamination adhesive 3 to form the polymer film 6.

The film, whether a composite, single ply, or laminate, preferably ranges in thickness from about 8 mil to 25 mils, and more preferably from about 15 to about 25 mils. Most preferably the polymeric film 6 is about 23-24 mils thick. In certain applications a thicker composite or a thinner composite may be appropriate to provide the required impact resistance. Films 6 thicker than 25 mils may be used; however they may not be desired in many applications as a thicker film will not have the same transmittance of visible light as windows with thinner films. Additionally, thicker laminates or coatings may negate the insulating effectiveness of the unit due to decreased air.

In a particularly preferred embodiment, the laminate 6 is constructed of 3 plies of 7-mil PET with a 1-mil UV absorbing layer on the top. Alternatively, one or more of the 7-mil plies have UV stabilizers directly incorporated into the layer and so an additional UV absorbing top layer is not included. The layers or plies are held together by a pressure sensitive adhesive. A pressure sensitive adhesive is also on the last layer for bonding to glass. Adhesives are those commonly known in the art but in choosing an adhesive several factors should be considered such as optical clarity, aged performance, and balance of adhesion and cohesive strength.

One preferred laminating adhesive is an acrylic pressure sensitive adhesive (“PSA”), such as pressure sensitive solvent-based adhesive available from LioChem Inc. The acrylic pressure sensitive adhesive is selected for its specific mechanical properties. Measurements of W_{d} (the work of detachment) in soft rubbers (of which pressure sensitive adhesives can be considered) illustrate that highly elastic systems are capable of dissipating energy upon detachment (W_{d}>>γ, where γ is the thermodynamic work of adhesion). The long-chain polymers that make up soft rubbers and many pressure sensitive adhesives such as acrylic based PSAs are cross-linked at large intervals, thereby eliminating local elastic energy return that would otherwise occur during polymer bond rupture and thus results in large W_{d}.

The visco-elastic properties of the PSA selected are preferably selected for compatibility with the specific film substrate. By laminating to an untreated PET surface the degree of cavitation/fibrillation at the adhesive-film interface is enhanced when subjected to elongational stresses (such as imparted by direct impact), resulting in a higher level of energy dissipation.

To prevent degradation of the polymeric film layers and adhesives, an ultraviolet light absorbing layer 4 can optionally be placed on an outermost layer of the composite. This layer can be impregnated with UV absorbing chemicals. In a preferred embodiment the layer is a PET based film of about 1-mil in thickness.

The composite 6 is adhered to the glass pane 15b with a mounting adhesive 2 placed on the outermost ply 5c of polymeric film composite 6. The adhesive can be any adhesive, but is typically a pressure sensitive adhesive. When a pressure sensitive adhesive is used, an optional disposable liner 9 is placed over the composite 6 until it is ready to be used. This liner is typically a 1-mil PET film coated with silicone. The liner 9 is removed prior to the polymeric film composite 6 being laminated to a pane of glass.

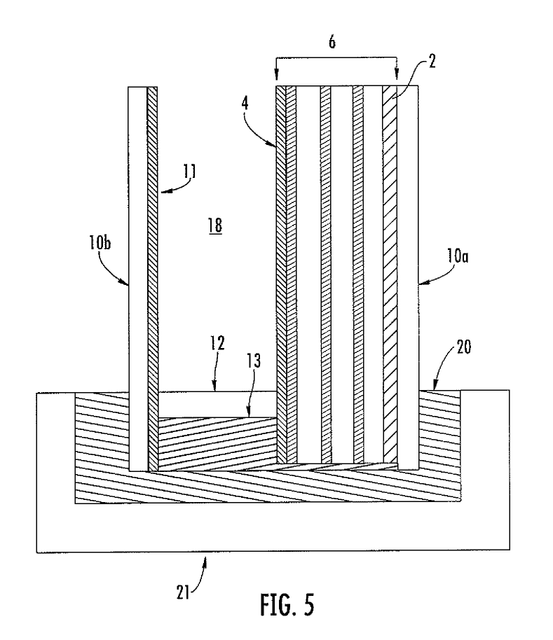

Referring to FIG. 5, the Insulated Glass Unit 6 is anchored to a window frame 21 by means of a structural adhesive 20. This adhesive can be a structural adhesive, glazing compound, glazing tape, or a combination thereof.

IGUs prepared in accordance with the present invention have numerous benefits. They are simpler to manufacture and offer reduced overall weight and reduced material usage while providing the same function as the more complex configurations of conventional IGUs. The configuration of the IGU of the present invention only requires two panes of glass and one polymer film on one side of one pane of glass. The result is a window that is much lighter and much more cost effective. The weight savings from the elimination of the third pane of glass can be up to 33%. With this pane removed, additional hardware and counterweights can be removed and an overall weight reduction in upwards of 50% is possible.

IGUs prepared in accordance with the present invention function as well as traditional impact resistant units. Ball drop tests show that impact resistance comparable to that of traditional glass laminates is achieved with an IGU constructed in accordance with the invention using a single polymer film as thin as 15 mils or 21 mils.

Another significant advantage is the increase in flexibility it gives in choosing materials for the IGU. Because of the reduction of required materials and layers as compared to prior impact resistant IGUs, there are many possible glass combinations, polymer films, etc. that can be used in construction of the IGUs. Conventional designs using film for impact windows required a specific combination of two types of low-e glass or alternatively three or more panes of glass. Additionally, conventional designs also require a film to be placed over one of the low-e glass coatings and/or a second low-e layer be placed on the innermost lite of glass (the one on the inside of the house). This conventional configuration makes a window that is particularly prone to damage through scratches and abrasion from cleaning. In contrast, the configuration of the present invention eliminates the need for the second low-e layer and/or a layer on the inside of a building.

The IGUs manufactured in accordance with the invention can more simply be constructed as low-e windows and meet Energy Star requirements. Using Windows program from LBNL Laboratories, the following simulations were run using Examples prepared in accordance with the invention including using various commercially available low-e glass coatings. Coating in the table below corresponds to numeral 11 in the figures.

Specifically the Examples were prepared by placing a film over a first pane of glass. The film in each example is the same and is a three ply laminate as described above (3 7 mils of PET) with a thickness of 21 mils. It is placed on the surface that corresponds to the inner surface 15a of the IGU. A second pane of glass using a low-e coating (identified as “Coating” in Table 1) was prepared and an IGU was formed from the two panes as describe above. The IGUs are constructed using clear glass with a ½ inch of air space with air fill. Results are illustrated in Table 1.

TABLE 1

| | Manu- | | | | | |
|---|---|---|---|---|---|---|
| Coating | facturer | U factor | SHGC | Tvis | Rfvis | Rbvis |
| Comfort Ti-AC36 | AFG | 0.298 | 0.353 | 0.65 | 0.12 | 0.15 |
| Comfort Ti-AC40 | AFG | 0.301 | 0.388 | 0.67 | 0.11 | 0.14 |
| Solarban 60 | PPG | 0.298 | 0.379 | 0.7 | 0.13 | 0.15 |
| Solarban 65 | PPG | 0.304 | 0.366 | 0.67 | 0.15 | 0.16 |
| Climaguard RLE | Guardian | 0.299 | 0.354 | 0.66 | 0.13 | 0.15 |
| 70/36 | | | | | | |
| Climaguard RLE | Guardian | 0.296 | 0.378 | 0.68 | 0.12 | 0.14 |
| 71/38 | | | | | | |

These are just a few examples of IGUs prepared in accordance with the invention and are not intended to limit the invention in any way. Energy Star requirements vary by region. For some regions a product must have a solar heat gain coefficient (SHGC)<0.40 and a U-factor <0.35. As illustrated in Table 1, IGU's constructed in accordance with the invention meet current Energy Star Requirements. As these requirements are increased, the design of the present invention allows for new types of glass to easily be placed into the system. IGUs prepared in accordance with the invention provide impact resistance while meeting Energy Star requirements. Conventional designs either fail to meet Energy Star requirements or fail to provide impact resistance.

For one comparative example, one conventional IGU design provides for a 15 mil film adhered to the inner side of both panes of glass; otherwise the IGU is prepared as the examples described above. This design, while providing some impact resistance, fails to meet Energy Star requirements for both SHGC and U factor by a significant margin (0.78 and 0.50 respectively). The presence of a low-e coating on the comparative example made no appreciable improvement in the performance.

Tvis represents the transmittance of visible light. Rfvis and Rbvis refer to reflection of visible light from the front and back side of the glass respectively. A higher Tvis is desirable, while lower values of Rfvis and Rbvis are desirable for aesthetic reasons. As illustrated in Table 1, the inventive IGU provide excellent visibility characteristics while providing impact resistance.

Because of the configuration of the glass and polymer film, the type of low-e glass available for use in IGUs is increased. Specifically, the inventive IGU design provides one pain of glass that has no film adhered to the inner surface. Accordingly, the low-e glass on the opposing surface can be easily changed out to customize the properties needed, for example for a given region. When film is used on both inner facing surfaces of glass as in conventional IGUs, these designs requires long term durability testing when placing a film over top of a low-e coating to determine the effect it will have on the low-e coating in terms of corrosion and other detrimental effects. In contrast, in the inventive design the film or laminate never touches the low-e coating. Accordingly, testing is not needed and the window manufacturer has the flexibility to choose or change the coating with no development time.

Finally, costs and inventory are reduced for manufacturers of the inventive IGU because the need to carry and use two types of low-e glass is eliminated. Additionally costs are reduced because plain glass is much cheaper than low-e glass. Finally, since the low-e layer on the new design is inside the IGU, it is protected from damage.

The inventive design also improves the aesthetic appearance of the glass and unit. By using only one layer of film, optical distortion of visible light is greatly reduced. The distortion level is expected to decrease by approximately 50% with the removal of one whole layer. Previous designs using two layers of film suffer from poor visual appearance since the wavelengths of light must go through many different layers of glass, pressure sensitive adhesive, and polyester. This present invention removes half or more of those layers resulting in much improved visual appearance.

Alternatives

There will be various modifications, adjustments, and applications of the disclosed invention that will be apparent to those of skill in the art, and the present application is intended to cover such embodiments. Accordingly, while the present invention has been described in the context of certain preferred embodiments, it is intended that the full scope of these be measured by reference to the scope of the following claims.

What is claimed is:

1. An impact resistant insulated glass unit comprising:
a first pane of glass with a polymeric film adhered onto one side of the pane of glass;
a second pane of glass linked to the first plane of glass to form the glass unit, wherein the second pane of glass does not have a polymeric film adhered to the side of the glass facing the interior of the glass unit; and
a spacer between the first and second pane of glass linking the first pane to the second pane of glass, thereby creating an insulating cavity in the glass unit between the first and second panes of glass,
wherein the first pane of glass is positioned so that the polymeric film side is facing the interior of the insulated glass unit.

2. The insulated glass unit of claim 1 wherein the polymeric film is a multi-ply film.

3. The insulated glass unit of claim 1 wherein the polymeric film includes at least one ultra-violet light absorbing layer.

4. The insulated glass unit of claim 1 wherein the second pane of glass is a low-e coated glass.

5. The insulated glass unit of claim 1 wherein the polymeric film is a three layer laminate of PET.

6. The insulated glass unit of claim 1 wherein the cavity of the unit contains an inert gas.

7. The insulated glass unit of claim 1 wherein the cavity of the unit contains a gas selected from the group consisting of Argon, Krypton or a mixture thereof.

8. The insulated glass unit of claim 2 wherein the outermost layer of the multi-ply film is an ultraviolet absorbing layer.

9. The insulated glass unit of claim 4 wherein the low-e coating is also ultraviolet absorbing.

10. The insulate glass unit of claim 1 further comprising a third pane of glass linked to the first and second pane of glass and positioned in between the first and second panes of glass thereby creating a first insulating cavity between the first and third panes of glass and a second insulating cavity between the second and third panes of glass.

11. The insulated glass unit of claim 1 further comprising backfill placed in the channel along the outer perimeter of the unit created by the two panes of glass and the spacer.

12. The insulated glass unit of claim 1 wherein the edge of the polymeric film is sealed to the glass with weatherable tape.

13. The insulate glass unit of claim 1 further comprising a third pane of glass linked to either the first or second pane of glass thereby creating a second insulating cavity.

14. A method for providing an impact resistant insulated glass unit comprising the following steps:
adhering or laminating a single ply or multi-ply, polymeric film onto the surface of a first pane of glass;
connecting the first pane of glass to a spacer so that the polymeric film side of the first pane of glass is in contact with the spacer;
connecting a second pane of glass to the spacer, thereby creating an insulating cavity on the interior of the insulating glass unit.

15. The method of claim 14 wherein the second pane of glass has a low-e coating.

16. The method of claim 14 further comprising backfilling the channel on the perimeter of the insulating glass unit.

17. The method of claim 14 further comprising connecting a second spacer to the opposite side of the second pane of glass; and
connecting a third pane of glass to the second spacer thereby creating a second insulating cavity on the interior of the insulating glass unit.

18. The method of claim 14 wherein the polymeric film is a three layer laminate of PET.

19. The method of claim 14 further comprising the step of sealing the edge of the polymeric film to the glass with weatherable tape.

20. An impact resistant insulated glass unit comprising:
a first pane of glass with a polymeric film adhered onto one side of the pane of glass;
a second pane of glass linked to the first plane of glass to form the glass unit, wherein the second pane of glass does not have a polymeric film adhered to the side of the glass facing the interior of the glass unit;
a third pane of glass linked to the first or second pane of glass, or linked between the first and second panes of glass; and
spacers between the panes of glass, thereby creating two insulating cavities in the glass unit between the three panes of glass,
wherein the first pane of glass is positioned so that the polymeric film side is facing the interior of the insulated glass unit.
